(19) United States
(12) Patent Application Publication
(10) Pub. No.: US 2010/0212784 A1
(43) Pub. Date: Aug. 26, 2010

(54) Utility Pole Grounding Wire Replacement with an Embedment Method and Device

(76) Inventor: Richard Charles Hannay, Conroe, TX (US)

Correspondence Address: MARK A OATHOUT, 3701 KIRBY DRIVE, SUITE 960, HOUSTON, TX, 77098, US

(21) Appl. No.: 12/712,137

(22) Filed: Feb. 24, 2010

Related U.S. Application Data
(60) Provisional application No. 61/155,015, filed on Feb. 24, 2009.

(51) Int. Cl. B27M 3/00

(52) U.S. Cl. 144/371; 144/2.1

(57) ABSTRACT

An electric transmission wood pole is selected for installation of a grounding wire using a grounding wire slot cutting device generally having two bases, two elongate guide members, a trolley, and a power tool mounted in the trolley. The two bases are adapted to be strapped to the wood pole. With the grounding wire slot cutting device mounted on the wood pole, a groove is cut along the wood pole. This procedure can be repeated to create a continuous groove along the wood pole. A grounding wire is pushed into the groove, and a sealer is applied over the grounding wire to fill the groove and to seal the grounding wire.

### CROSS-REFERENCE TO RELATED APPLICATIONS

This application claims the benefit of U.S. Provisional Application No. 61/155,015 filed Feb. 24, 2009.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A “SEQUENCE LISTING”, A TABLE, OR A COMPUTER PROGRAM

Not Applicable.

### BACKGROUND

Copper theft poses a threat to customer safety in the utility industry. Power companies use copper wire to ground high-voltage apparatus that sit atop wooden utility or power poles. This copper wire is traditionally stapled to a wood pole from the top of the pole to just below the ground line, where it is attached to a ground rod buried perhaps eight feet into the earth. These ground wires provide system protection from lightning strikes, supply an alternate path for the neutral conductor in alternating current systems, and ground the metal cases of transformers and related equipment.

Ground wires on existing wood utility poles that connect to the earth's crust can become broken or stolen. Traditionally, such a broken or stolen ground wire is replaced by a lineman. The lineman scales the pole with a line and staples, runs an entirely new line, and staples the new line to the pole working down the pole. This new line runs the entirely same risk (as the ground line that has just been replaced) of being broken or stolen in the future.

For purposes of this application “hot stick” shall mean an insulated pole (normally, but not limited to, round in cross-section) usually made of fiberglass (or other suitable insulating material) allowing utility workers to safely perform operations on high-voltage electric power line(s) while energized or without knowing the energized state of such power line(s).

### SUMMARY OF THE INVENTION(S)

An existing or new wood pole is selected for installation of a grounding wire. The grounding wire slot cutting device is mounted on the wood pole and a groove is cut along the wood pole. This procedure can be repeated until a continuous groove of the desired length is cut along the wood pole. A grounding wire is pushed into the groove, and a sealer is applied over the grounding wire to fill the groove and to seal the grounding wire. This results in a grounding wire that is not visible or accessible on the outside of the pole.

The grounding wire slot cutting device generally has two bases, two suitable elongate guide members, the trolley, and a power tool mounted in the trolley. The two bases are adapted to be strapped to the wood pole. Two suitable elongate guide members shown in this embodiment as hot sticks are attached to the bases. The elongate guide members extend in the direction parallel to the center axis of the pole and function to guide the trolley along the wood pole. The trolley supports the power tool and travels along the two suitable elongate guide members. The power tool cuts the groove along the wooden pole.

### BRIEF DESCRIPTION OF THE SEVERAL VIEWS OF THE DRAWING(S)

FIG. 1 is an elevation view of a traditional utility pole.

FIG. 2 is a view of one embodiment of a ground wire slot cutting device used in placing a new grounding wire on a utility pole.

FIG. 2A is a view of another embodiment of a ground wire slot cutting device used in placing a new grounding wire on a utility pole.

FIG. 3 is a perspective schematic view of a power tool cutting a groove in a utility pole for embedding a new ground wire.

FIG. 4 is an elevation view of a lineman working together with another person in placing a new grounding wire on a utility pole.

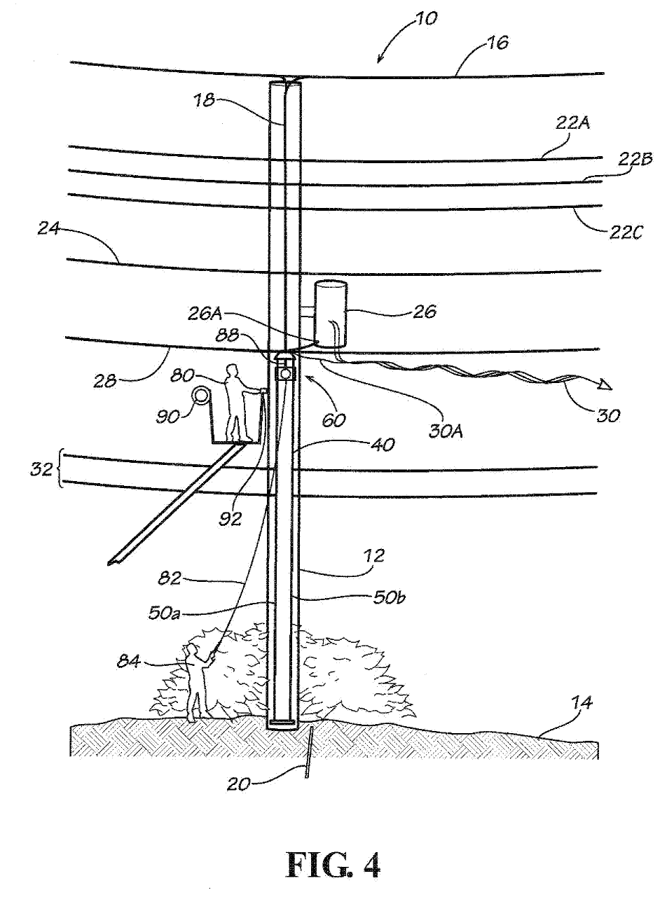

### DETAILED DESCRIPTION OF PREFERRED EMBODIMENT(S)

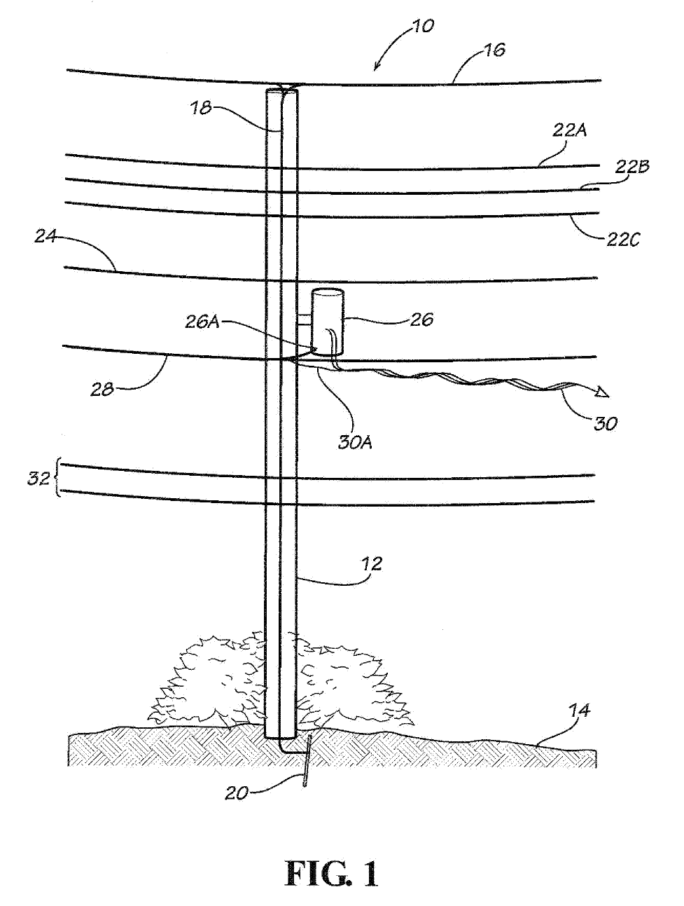

With reference to FIG. 1, a utility pole 10 is shown. The utility pole 10 for purposes of this application is a wood pole 12 (or other composite allowing mechanical working of the outer surface). The utility pole 10 generally ranges from twenty to one-hundred feet tall with thirty-five feet being a more common pole height. In a normal case the utility poles 10 are buried about six feet deep into the earth's crust 14 and are spaced consecutively, by way of example, about 125 feet apart.

By way of example, a common utility pole 10 may include all or portions of the following. A static wire 16 extends across the top of the utility pole 10 to bleed lightning surges off the power lines during a storm. A grounding wire (conductor) 18 is connected to the static wire 16 and to a grounding rod 20. The grounding wire 18 runs the entire length of the wood pole 12. Transmission lines 22a, 22b, 22c carry high voltage electricity (69-500 kilovolts) in three phases to substations (not shown). Primary phase conductors 24 convey electricity (5-30 kilovolts) from the substations and are part of the distribution system wires (which can be one, two or all three phases). On older poles the primary phase conductors 24 are often supported by crossbars (not shown). A step down transformer 26 (for converting to lower voltages used in homes or businesses) is connected to one of the primary phase conductors 24 with the transformer case 26a connected to the grounding wire 18 on the wood pole 12. A neutral grounded conductor 28 is also part of the distribution system and provides a return path for electricity. The neutral grounded conductor 28 may be referred to as a multi-grounded neutral if also connected to the grounding wire 18. A secondary service drop 30 conveys electricity (120/240 volts) to the end user/load (not shown). The secondary service drop 30 consists of three wires including a bare neutral wire 30a connected to the grounding wire 18 at the wood pole 12. Communication lines 32 may be attached to the wood pole 12 normally along a lower space or area of the wood pole 12. The grounding rod 20 is buried in the earth's crust 14 proximate the base of the wood pole 12, and is connected to the grounding wire 18.

For purposes of the present application it is noted that the grounding wire 18 on the wood pole 12 runs the risk of becoming broken or stolen. Hence the motivation for the subject matter of the present disclosure.

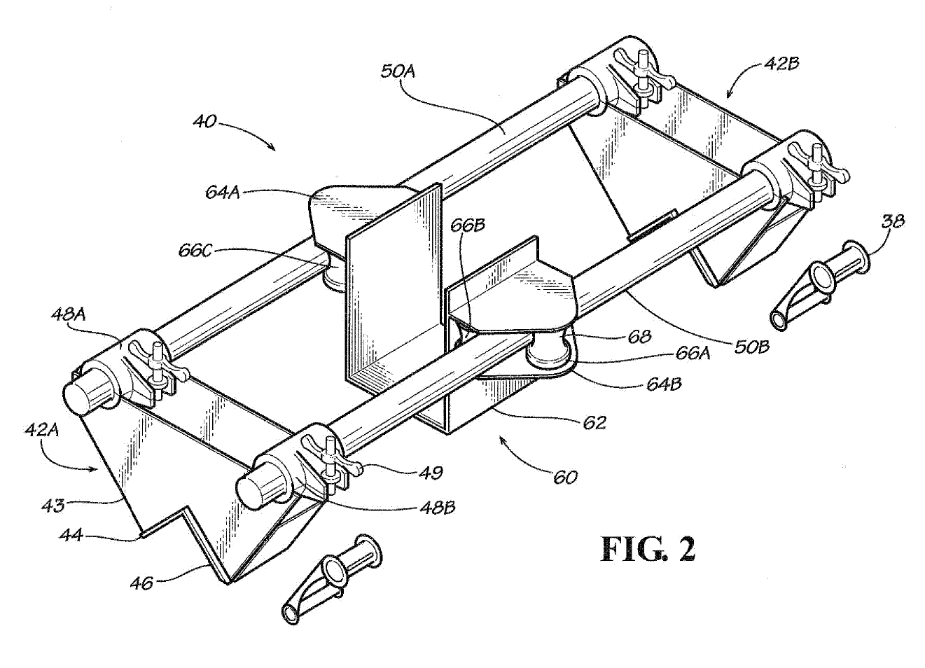

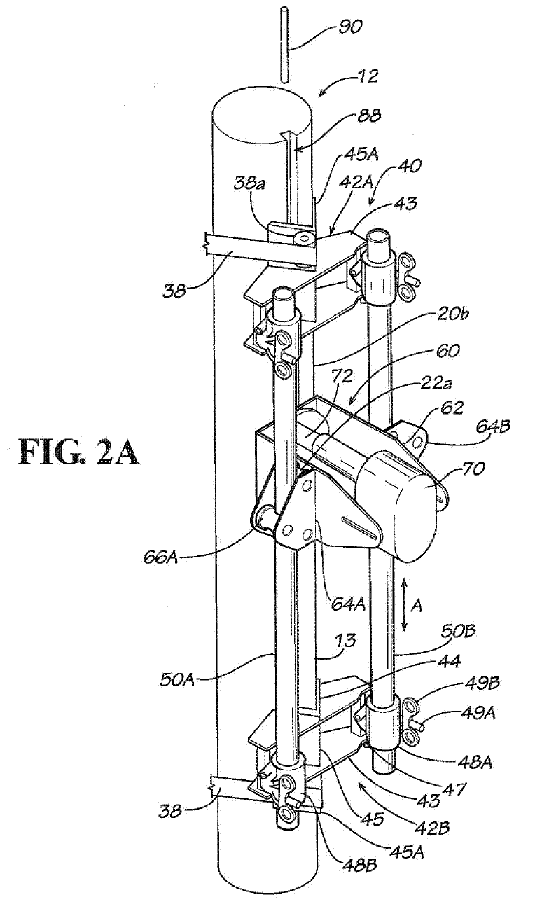

Referring to FIGS. 2 and 2A, an embodiment of a grounding wire slot cutting device 40 is shown. The grounding wire slot cutting device 40 generally includes at least two bases 42a and 42b, one or more elongate guide members shown in this embodiment as hot sticks (e.g. fiberglass rods) 50a and 50b, and a carriage or trolley 60 for the mounting of a power tool 70 (e.g. a router, skill saw, power saw or the like).

Bases 42a and 42b each include a boom body 43, a prehensile surface 44, and attachment pieces 48a and 48b. The prehensile surface 44 is adapted for mounting or saddling to the curvature of pole surface 13 of wood pole 12 (the prehensile surface 44 is V-shaped as shown, although other shapes could be used such as, for example, U-shaped or semi-circular). The prehensile surface 44 may be made of a length of angle iron 45 (FIG. 2A) mounted into the boom body 43 so as to extend adjacent pole surface 13. Prehensile surface 44 is oriented so that curvature of the pole surface 13 nests in the angle formed between the sides of the prehensile surface 44. A gripping pad 46 is optionally adhered to the prehensile surface 44. The attachment pieces 48a and 48b (clam shell closing collars as shown in this embodiment) function as clamps and are used for attaching the hot sticks 50a and 50b via bolts 49. The attachment pieces 48a and 48b may be releasably secured closed by means of threaded bolts 49a and corresponding threaded wing nuts 49b which secure the attachment pieces 48a and 48b closed about their respective hinge 47. Attachment pieces 48a and 48b are secured on the boom body 43 equidistantly from each other on each boom body 43 such that the hot sticks 50a and 50b run parallel and are held rigidly spaced apart at a desired distance (i.e. the hot sticks 50a and 50b are securely attached with an established distance and parallel to each other at each of the ends via the boom body 43). This aides in positioning the cutting blade 72 against and into the surface 13 of wood pole 12 as the mounting bracket 62 is translated along the length of the elongate guide members 50a, 50b.

The trolley 60 (which in the embodiment shown is adapted for the mounting of a router) has a mounting bracket 62 (U-shaped in the embodiment shown), two guide brackets 64a and 64b, and at least two rollers 66 (in the embodiment shown six rollers are implemented with three of the rollers 66a, 66b and 66c viewable in FIG. 2). The mounting bracket 62 is adapted for mounting of the power tool 70 and may have an aperture at the base for allowing penetration of the tool bit, or cutting blade 72. The guide brackets 64a and 64b are secured to the U-shaped bracket 62. The rollers 66 preferably have a tapered surface 68 to fit the contours of the outer surface of the hot sticks 50a and 50b thereby allowing the trolley 60 to be guided by and travel along the hot sticks 50a and 50b.

Angle iron 45 may extend outwardly beyond boom body 43 to provide an extension 45a over which strapping 38 (e.g. nylon strapping) may be mounted so as to wrap around wood pole 12 thereby releasably securing grounding wire slot cutting device 40 against surface 13. It is understood that strapping 38 may be resilient or flexible straps or belts and/or other tensioners which may be wrapped around or mounted to wood pole 12. Strapping 38 is releasably secured and tensioned for example by ratcheting latches 38a or other tightening means known in the art so as to hold grounding wire slot cutting device 40 in position sufficiently securely so that power tool 70 may be employed to cut groove 88 along the length of wood pole 12 between the pair of bases 42a and 42b. Strapping 38 can be sequentially released and the grounding wire slot cutting device 40 can be reset so that a continuation of groove 88 may be cut.

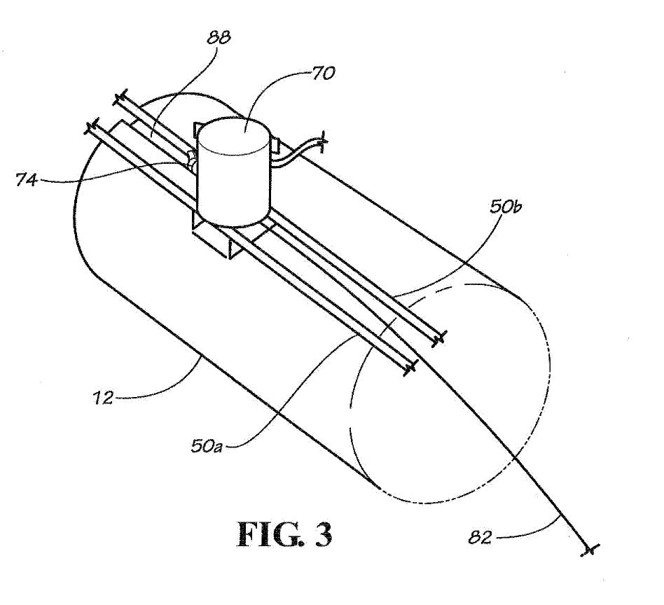

With reference to FIG. 3 a power tool 70 (such as an off-the-shelf power tool) is mounted in the trolley 60. The trolley attachment is configured to attach an electric power tool 70 with adjustments that can vary the power tool's distance from pole surface 13; hence the depth of groove or slot 88 can be altered according the particular wire size (i.e. American wire gage standards can be used for provision of the adjustment needed to fully embed a wire of a particular diameter). An optional biasing element (not shown) may be mounted on trolley 60 or power tool 70 such that the biasing element is interposed between the wood pole 12 and the carriage 60 to draw the power tool blade to a desired depth. Likewise, selection of the tool bit, cutting blade 72, or the like is used to cut, saw, route, drill, chip, gouge, burn or otherwise vaporize or remove to form the desired groove or slot 88. For example, a tool bit 72 slightly smaller than the ground conductor (no. 6 American Wire Gauge is slightly greater than 0.072 inches) is installed into the power tool 70. The electric cord attaches to the power tool 70 (a battery powered power tool may be implemented) with an on/off switch preferably installed on the cord at the ground level in addition to an endless line 82 for the person 84 on the ground to control the power tool 70.

A plowing, harrowing, brushing, blowing or vacuuming device 74 (e.g. a spring-loaded U-shaped piece (FIG. 3) that flips or rotates forward or backward, a brush, or small blower/vacuum) may be added to the trolley 60 or power tool 70 for the purpose of removing or dragging sawdust and other matter out of the groove 88 as the power tool 70 travels along the wood pole 12 and cuts the groove 88.

The following procedures or instructions are intended to explain how to replace a broken or stolen grounding wire 18 from existing wood poles 12 that connect with the earth's crust 14 with an embedded (and somewhat camouflaged) wire 90 to maintain the integrity of the electrical system. When the grounding wire 18 is replaced by embedment, such is also intended to reduce or eliminate the load on the neutral grounded conductor 28 caused by the loss of the original grounding wire 18.

First, a lineman 80 climbs the wood pole 12 (this discussion assumes the pole is vertical although other orientations are possible) up to the neutral grounded conductor 28 (e.g. twenty-two feet above the ground) and drops a hand line 82.

Next, the ground man 84 attaches the hand line 82 to the top of the grounding wire slot cutting device 40 and raises it to the lineman 80, who attaches the grounding wire slot cutting device 40 to the wood pole 12 and secures it (e.g. using strapping 38 through the bases 42a and 42b, chains, screws, or the like). Once attached, the hot sticks 50a and 50b may, for example, extend for twenty feet along the wood pole 12 to the ground. Then the lineman 80 adjusts the power tool 70 to the correct depth for the slot or groove 88 desired.

While the lineman 80 is climbing the wood pole 12, the ground man 84 is excavating around the wood pole 12 to find the ground rod 20 and removes the ground rod clamp or locates the end of the butt wrap grounding wire 18.

The lineman 80 then climbs above the grounding wire slot cutting device 40 to be out of harms way for a period of time while the device 40 is cutting the groove 88 in the wood pole 12.

The ground man 84 then activates the power tool 70 and pulls it along with the trolley 60 to the earth's crust 14. This procedure cuts the groove 88 in the wood pole 12. The groove 88 is cut to a size sufficient to house or embed the grounding wire 90.

The ground man 84 then attaches the new ground wire 90 and a split bolt connector to the hand line 82 and carefully, keeping the ground wire 90 taunt, raises the items to the lineman 80.

The lineman 80 staples the ground wire 90 above the slot 88, with a pigtail long enough to clamp to the neutral grounded conductor 28.

The lineman 80 detaches the ground wire slot cutting device 40 and lowers it to the surface of the earth's crust 14.

The lineman 80 then applies the furnished epoxy, glue, compound, rigid or semi-rigid cover 92 (e.g. an off the shelf glue sold under the brand name GORILLA GLUE), all of the foregoing for sake of convenience being referred to as “glue” or a “sealer”, into the groove or slot 88 allowing it to run into the slot 88 and, by way of example, hammers or taps the wire 90 into the slot and glue 92 as he descends the wood pole 12 to embed the wire 90 into the glue 92 and the slot 88 in the wood pole 12. The color of the glue 92 may be selected such as to camouflage the existence of the groove 88 (for example, from those who would seek to remove the wire for the value of the copper).

When the lineman 80 reaches the surface of the earth's crust 14; the connection is made to the ground rod 20 or the tail from the butt wrap.

Should the glue 92 expand profusely from the wood pole 12 while drying, the extruded portion can be knocked-off.

Last, the workers backfill the excavated soil to rework the area as needed.

The embedded ground wire 90 is almost impossible to remove from the wood pole 12 and therefore prevents theft and breakage. The wood pole 12 can be worked on either with the wood pole 12 in a vertical or a horizontal position but is discussed above as if the arrangement were vertical.

1. A grounding wire slot cutting device for cutting a groove in a wood pole, wherein the wood pole is used for transmission of utilities such as electricity, comprising:
two bases connectable to the wood pole;
an elongate guide member attached to the two bases and extending parallel to a center axis of the wood pole when the grounding wire slot cutting device is connected to the wood pole; and
a trolley mountable in travelling relationship along the elongate guide member.

2. The apparatus according to claim 1, further comprising a power tool mounted in the trolley within proximity for cutting a groove in the wood pole when the grounding wire slot cutting device is connected to the wood pole.

3. The apparatus according to claim 2, wherein the power tool is an off-the-shelf power tool.

4. The apparatus according to claim 1, wherein said elongate guide member comprises two hot sticks held rigidly spaced apart from each other by the two bases, and wherein said two hot sticks are held running parallel to each other.

5. The apparatus according to claim 4, wherein said trolley comprises a mounting bracket and two guide brackets attached on opposite sides of the mounting bracket, wherein the two guide brackets are adapted for travelling relationship along said hot sticks.

6. The apparatus according to claim 5, wherein each of the guide brackets include a plurality of rollers mounted in the guide brackets, wherein the rollers are tapered to receive said hot sticks.

7. The apparatus according to claim 6, wherein the mounting bracket has an aperture adapted to allow penetration of a cutting blade of a power tool.

8. The apparatus according to claim 1, wherein each of the two bases include a prehensile surface located on a side upon which each of the two bases are to be connected to the wood pole.

9. The apparatus according to claim 8, further comprising a gripping pad adhered to the prehensile surface.

10. The apparatus according to claim 8, wherein the prehensile surface comprises a length of angle iron extending beyond each of the two bases.

11. The apparatus according to claim 10, further comprising a strapping for securing the grounding wire slot cutting device to the wood pole over the length of angle iron extending beyond each of the two bases.

12. The apparatus according to claim 1, further comprising a means for removing sawdust from a groove located in the wood pole, wherein the sawdust removing means is mounted on said trolley.

13. The apparatus according to claim 1, further comprising:
a. a power tool mounted in the trolley within proximity for cutting a groove in the wood pole when the grounding wire slot cutting device is connected to the wood pole;
b. wherein said elongate guide member comprises two hot sticks held rigidly spaced apart from each other by the two bases, and wherein said two hot sticks are held running parallel to each other;
c. wherein said trolley comprises a mounting bracket and two guide brackets attached on opposite sides of the mounting bracket, wherein the two guide brackets are adapted for travelling relationship along said hot sticks; and
d. wherein each of the two bases include a prehensile surface located on a side upon which each of the two bases are to be connected to the wood pole.

14. The apparatus according to claim 13, wherein the prehensile surface comprises a length of angle iron extending beyond each of the two bases.

15. The apparatus according to claim 14, further comprising a strapping for securing the grounding wire slot cutting device to the wood pole over the length of angle iron extending beyond each of the two bases.

16. The apparatus according to claim 13, further comprising a means for removing sawdust from a groove located in the wood pole, wherein the sawdust removing means is mounted on the grounding wire slot cutting device.

17. A method for embedding a grounding wire in a wood Pole, wherein the wood pole is used for transmission of utilities such as electricity, comprising the steps of:
a. attaching a device to the wood pole, wherein the device is adapted for forming a groove in the wood pole;
b. making any necessary adjustments for creating a groove of correct depth in the wood pole;
c. forming a groove in the wood pole using the device, the groove being of sufficient size to house a grounding wire in the wood pole;
d. applying a glue into the groove along the wood pole;
e. embedding the grounding wire into the glue and into the groove along the wood pole.

18. The method according to claim 17, further comprising the step of detaching the device from the wood pole and sequentially reattaching the device to a different location along the wood pole for forming a continuous groove along the wood pole by pulling a trolley along the device.

19. The method according to claim 17, further comprising the step of removing sawdust from the groove formed in the wood pole.

20. The method according to claim 17, wherein the wood pole is an existing wood pole in a vertical position, and further including the steps of:
a. wherein said step of attaching the device to the wood pole is initially carried out by way of a lineman climbing toward the top of the wood pole;
b. wherein said step of forming the groove is carried out by way of a ground man pulling the device down the wood pole; and
c. wherein said step of applying the glue is initially carried out by way of the lineman toward the top of the wood pole.
